(19) United States
(12) Patent Application Publication
(10) Pub. No.: US 2014/0123740 A1
(43) Pub. Date: May 8, 2014

(54) Working Abnormality Detecting Device and Working Abnormality Detecting Method for Machine Tool

(71) Applicants: Takehisa Yoshikawa, Tokyo (JP); Hideaki Onozuka, Tokyo (JP); Nobuaki Nakasu, Tokyo (JP)

(72) Inventors: Takehisa Yoshikawa, Tokyo (JP); Hideaki Onozuka, Tokyo (JP); Nobuaki Nakasu, Tokyo (JP)

(73) Assignee: Hitachi, Ltd., Chiyoda-ku, Tokyo (JP)

(21) Appl. No.: 14/124,142

(22) PCT Filed: May 7, 2012
(86) PCT No.: PCT/JP2012/061673

§ 371 Date: Dec. 5, 2013

(30) Foreign Application Priority Data
Jun. 9, 2011 (JP) 2011-129526

(51) Int. Cl. G01N 19/08

(52) U.S. Cl. CPC G01N 19/08
USPC 73/104

(57) ABSTRACT

Provided are a device and a method which determine a threshold value for detecting abnormality in a working path in which the cutting condition changes momentarily to thereby enable abnormality determination. Cutting force that becomes an abnormality determination value and threshold value information are previously calculated by cutting simulation, and a threshold value with which a comparison is to be made is determined from the position coordinates of a working machine which have been acquired during cutting and the measurement result of cutting force to thereby enable abnormality determination.

### TECHNICAL FIELD

The present invention relates to a control device and control method for detecting working abnormalities such as tool wear and chatter vibration that occur during processing, and suppressing the working abnormality caused by work damage due to excessive wear or chatter vibration, in a machine tool subjected to numerical control, and especially in a machine tool subjected to numerical control used for milling and cutting operations.

Further, the preset invention relates to a working abnormality detecting device and working abnormality detecting method in a machine tool subjected to numerical control, wherein a cutting force as abnormality determination value (model) based on a cutting simulation corresponding to cutting conditions and threshold value information are calculated in advance, and a position coordinate of a cutting tool of the machine tool acquired during actual cutting work and a measurement result of the actual cutting force are acquired to determine the threshold value to be used for comparison, so as to enable abnormality determination.

### BACKGROUND ART

End milling using a machine tool is a common working method for processing metal components into various shapes, wherein a cutting blade attached to a rotating tool is used to cut into a cut target material and remove material therefrom to process the material into various shapes. Normally, cutting work involves a large number of steps for cutting out component shapes from square blocks and round bars, and a large amount of material must be removed to process components having complicated shapes, so that efficiency is enhanced by increasing the cutout depth, the feed rate, the tool rotation speed and the like. Recently, in order to enhance the product performance, high-intensity, difficult-to-cut materials such as Ni-based alloy and super-hard cast steel material are often adopted in components being the target of the cutting work, so that the cutting conditions must be set with a deteriorated processing efficiency, causing a drawback in the attempt to realize automation and highly efficient operation. Furthermore, the processing shapes have become complex, such as with a three-dimensional curved surface, so that more and more processing is performed using a multiaxial machine tool such as a five-axis machining center, and the improvement of processing efficiency to overcome the above-mentioned drawback has become a problem.

In processing such materials into desirred shapes, depending on the cutting quantity or the rotation speed of the rotation shaft, the force applied on the cutting blade increases when the cutting quantity or the tool rotation speed is increased, so that processing problems caused by vibration (chatter) of the tool or the wear and damage of the cutting blade occur easily. When such processing problem occurs, the surface roughness of the processed section may be deteriorated or damaged, and material must be discarded, so that expensive high-intensity material and tools are lost and disposal costs occur, causing increase of manufacturing costs. Therefore, a means for monitoring the vibration status and processing status of the machine tool and for outputting a command to the machine tool immediately before abnormality occurs to change the work conditions (such as reduction of tool rotation speed), or a technique for constituting a machining control system and control method capable of stopping the working process is required.

Related to such problems of the prior art, there are various methods for detecting the abnormality of the cutting operation by various methods. As shown in patent literature 1 and non-patent literature 1, as a method for detecting cutting abnormality caused by tool wear or the like, there is known a method for detecting abnormality where the load of a motor is estimated by measuring a drive current of a motor used for rotating a spindle, and the load is compared with a threshold value set in advance. Patent Literature 1 (Japanese Patent Application Publication No. 59-146741) teaches “a device for detecting abnormality of cutting, which stores a model data as load data during cutting of a model work, and compares a load data during actual cutting momentarily with the model data, comprising a comparator which does not treat a difference due to the difference of comparing time as the abnormality of cutting if there is a model data identical to a load data during actual cutting in the stored model data within a predetermined allowable time range set in advance based on a given time”.

Patent Literature 2 teaches a method for setting a threshold value of a motor load by recognizing a variation pattern of a motor driving current via experiment or simulation, and setting the threshold value for each working path based on this variation pattern. Patent Literature 2 (Japanese Patent Application Laid-Open Publication No. 5-337790) provides “a tool abnormality sensing device which senses failure of a machine tool performing processing by selecting a machining tool according to a working program, comprising a processing load sensing means for sensing the working load by the working tool, a data storage means for storing a threshold value data for determining tool life for determining the life of the tool in each work stage executed by the working tool according to the working program, a detection start time data showing the time in which detection is started, and a monitor time data showing the monitored time, a comparing/judging means for reading each data corresponding to the working tool from the data storage means and comparing the threshold value data for determining the tool life and the output value of the work load detecting means within the monitored time set by the data in order to determine the abnormality of the tool, and an abnormality waveform storage means for storing the dynamic waveform during abnormal working according to the determination output of abnormality of the comparing/judging means”.

Further, Patent Literature 3 shows a method for correcting a control parameter of a machining device by comparing a cutting load obtained from a current value of a spindle motor with a predicted value of a cutting force based on a combination of a predetermined cutting pattern (fixed cycle). Patent Literature 3 (Japanese Patent Application Laid-Open Publication No. 2006-338625) discloses “a machining control system for an NC machine tool characterized in that an NC program is created to optimize a predicted value of a cutting resistance applied on the end mill by determining a transmission path and a feed rate of the end mill within fixed cycles, by replacing a working region of an object to be processed with a combination of fixed cycles determined in advance to perform a predetermined working process to the object to be processed using an end mill, to thereby have the NC machine tool perform working operation according to a control command given according to the NC program, comprising an actual resistance calculating means for calculating a cutting resistance actually applied on the end mill during processing of the object to be processed, a feed forward control element for performing feed forward-correction of the control command, and a means for changing a control gain of the feed forward control element based on the calculated result of the actual resistance calculation means.

### CITATION LIST

### Patent Literature

### [PTL 1] Japanese Patent Application Laid-Open Publication No. 59-146741

### [PTL 2] Japanese Patent Application Laid-Open Publication No. 5-337790

### [PTL 3] Japanese Patent Application Laid-Open Publication No. 2006-338625

### Non Patent Literature

### [NPL 1] JIPM Solutions, Laboratory for Visualizing Work Point, “Work Point Visualizing Technique” (2008) pp. 85-93

### SUMMARY OF INVENTION

### Technical Problem

However, according to the method for setting up a set value in advance for each component, experiments and testing operations for setting threshold values for each component shape becomes necessary, and it does not offer a realistic solution when there are a large variety of components. Even further, according to the method for setting up a threshold value in advance for each working path, the threshold value can only be applied when the cutting quantity in a single working path is constant, and the method cannot easily be applied to a case where the cutting quantity varies and the working load varies. Further, according to the method for performing processing by defining a cutting pattern in advance, the method can be applied to a case where the component shapes can be dissolved to cutting patterns to a certain level, but if a varying curved surface is to be processed, it is difficult to set up a threshold value for comparison. Especially, in processing a complicated three-dimensional shape processed via a five-axis cutting device in which the cutout and the feed rate vary momentarily, it is necessary to divide the working path into a number of short working paths, so that it is difficult to set up threshold values for each of the number of working paths.

Now, as shown in Patent Literatures 2 or 3, the method for detecting abnormality by comparing the cutting force with a simulation result for predicting the cutting force based on cutting conditions is effective in fixed cutting patterns. However, if the cutting conditions differ as in the processing of a curved surface, it is difficult to recognize the current position being processed. The object of the present invention is to provide a method for determining a threshold value for detecting abnormality of the cutting work by recognizing the current position being processed even in a working path where the cutting quantity varies momentarily.

### Solution to Problem

In order to solve the above-mentioned problems, the present invention provides a working abnormality detecting device for a machine tool subjected to numerical control, comprising: a cutting position—work condition storage means storing a work condition related to a coordinate value of a cutting tool during cutting work; a calculated cutting force storage means for storing a calculated value of a cutting force associated with the coordinate value of the cutting tool; a measurement means for measuring an actual cutting force of the cutting tool during the cutting work; a coordinate value acquisition means for acquiring an actual coordinate value of the cutting tool during the cutting work; a calculated cutting force pattern extraction means for extracting identical patterns by comparing a pattern of a calculated cutting force stored in advance by the calculated cutting force storage means and a pattern of the actual cutting force acquired via the measurement means; a delay time computing means for computing a delay time of the actual cutting force by comparing the actual cutting force pattern and the calculated cutting force pattern via the calculated cutting force pattern extraction means; a threshold cutting force storage means for storing a threshold cutting force for determining abnormality based on the work condition associated with the coordinate value of the cutting tool; and an abnormality determination means for determining whether there is abnormality by comparing the actual cutting force of the cutting tool at the coordinate value and the threshold cutting force for determining abnormality.

The working abnormality detecting device for a machine tool subjected to numerical control according to the present invention characterizes in that the measurement means is composed of a force sensor built into a spindle section of a machining device.

The working abnormality detecting device for a machine tool subjected to numerical control according to the present invention characterizes in that the measurement means is composed of a force sensor disposed between a table of the machining device and a cut target material.

The working abnormality detecting method for a machine tool subjected to numerical control includes a first step of acquiring a coordinate position information of a cutting tool during cutting work; a second step of acquiring an actual cutting force during cutting work; a third step of comparing a pattern of the actual cutting force acquired in the second step and a pattern of a cutting force predicted in advance by calculation; a fourth step of calculating a delay time between the pattern of the predicted cutting force based on the comparison result and the pattern of the actual acquired cutting force; a fifth step of determining a predicted value according to the cutting force pattern stored in advance based on the calculated delay time; and a sixth step of determining whether working abnormality has occurred by comparing the predicted value and the measured actual cutting force.

### Advantageous Effects of Invention

According to the present invention, it becomes possible to determine a threshold value for detecting abnormality of the predicted value of cutting force to be compared based on the measurement value of the cutting quantity, so that it becomes possible to detect abnormality in machining a curved surface, to improve the efficiency of the cutting work and to cut down costs of the products.

Even further according to the present invention, the working abnormality detecting device of the numerically controlled machine tool has the measurement means of the machine tool built into the spindle of the machining device, such as a force sensor disposed between the table of the machining device and the cut target material, so that the configuration can be realized inexpensively compared to forming a dedicated numerically controlled machine tool, and can be easily realized in a general-purpose numerically controlled machine tool.

### BRIEF DESCRIPTION OF DRAWINGS

FIG. 1 is a flowchart illustrating the steps of a working abnormality detecting method according to embodiment 1 of the present invention.

FIG. 2 is an outline of a configuration illustrating components constituting a machining device according to the present invention.

FIG. 3 is a layer configuration diagram showing the configuration of a control unit for detecting the working abnormality according to the present invention.

FIG. 4 is a working status view illustrating a common rectilinear cutting work.

FIG. 5 is a working status view for illustrating a cutting work in which the direction of movement of the tool varies in the direction of the plane.

FIG. 6 is a working status view for illustrating a cutting work in which the direction of movement of the tool varies in the vertical direction.

FIG. 7A is a view illustrating a variation of the result of cutting force measurement and a curve (profile) in which the maximum value of cutting force of a single blade is extrapolated, in the case where a rectilinear cutting work is executed.

FIG. 7B is a view illustrating a variation of the result of the cutting force measurement and a curve (profile) in which the maximum value of cutting force of a single blade is extrapolated, in the case where the cutting direction varies.

FIG. 8 is a view for detecting working abnormality, illustrating a method for calculating delay time based on a cutting force measured according to the present invention.

FIG. 9 is a view of a table storing the relationship between a feed rate of a working tool and a delay time according to embodiment 1 of the present invention.

FIG. 10 is a view showing the relationship of components of a working abnormality detecting device according to a second embodiment of the present invention.

### DESCRIPTION OF EMBODIMENTS

The present invention provides a working abnormality detecting device and detecting method for determining abnormality in a working path of an NC machine tool whose cutting condition varies momentarily, by determining a threshold value for detecting abnormality in advance and comparing the same with an actual cutting force. Now, the preferred embodiments for carrying out the present invention will be described with reference to the drawings. In the following description, the same components are denoted with the same reference numbers, and will not be explained repeatedly.

### Embodiment 1

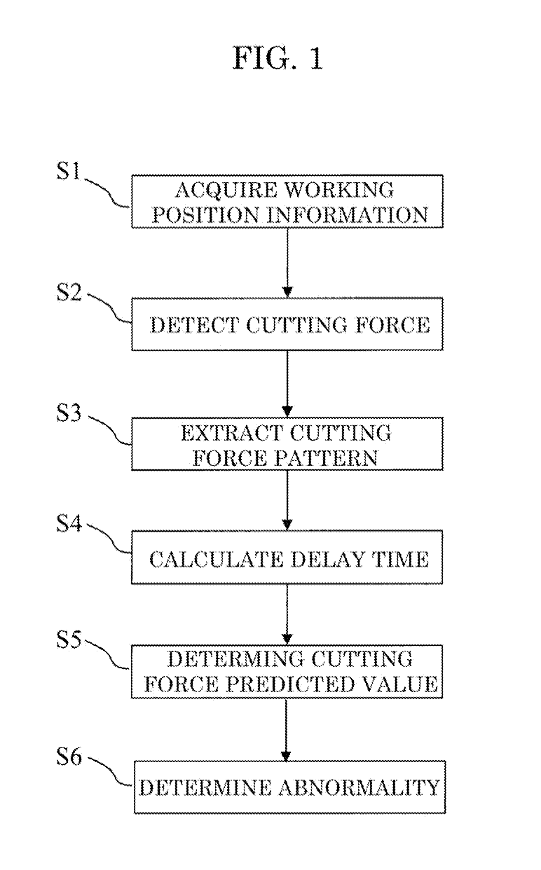

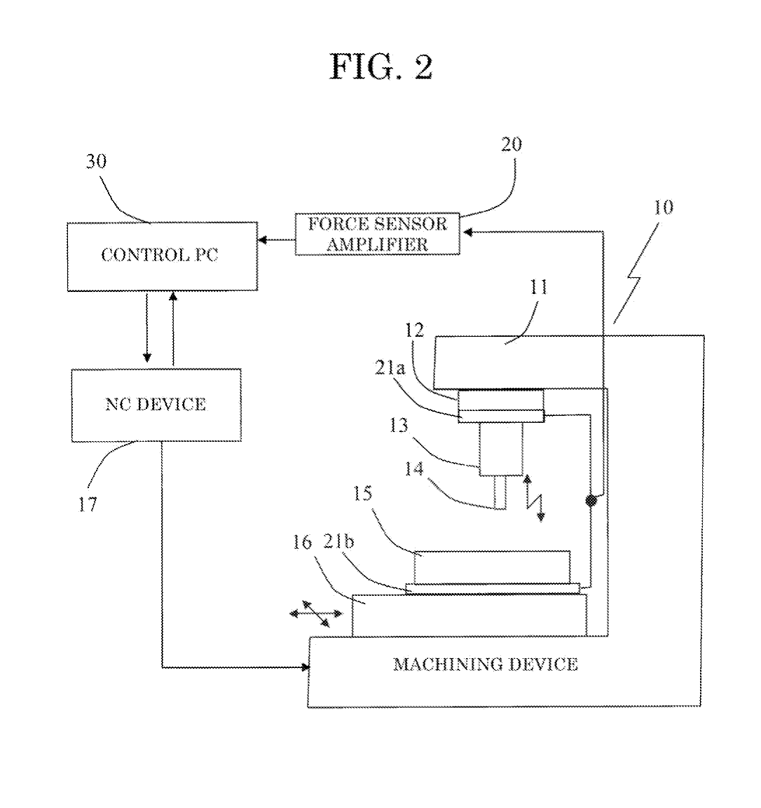

The first embodiment of the present invention will be described with reference to FIGS. 1 through 9. FIG. 2 shows an outline of the components constituting a device of a machining control system of a machine tool according to the preferred embodiment of the present invention. The present embodiment takes a machining device performing triaxial control as an example, but the number of controlled axes or the configuration of the device is not limited to the illustrated example. The present machining control system is applied to a machining device 10 which is a common triaxially-controlled machine tool, composed of a chassis 11 of the machining device 10, a working tool 14, a spindle 13 holding and rotating the working tool 14, a spindle stage 12 for moving the spindle 13 in a Z-axis direction (vertical direction), a cut target material 15, a table 16 for holding and moving the cut target material in the direction of X-Y axes (horizontal direction), an NC device 17 for controlling the movement of the machining device 10 in the directions of the X-Y-Z axes, a cutting force measurement sensor 21a to be attached to the spindle 13 for measuring the cutting force, a cutting force measurement sensor 21b to be attached between the table 16 and the cut target material 15 to measure the cutting force, and a control PC 30 for communicating with the NC device 17 and storing the measurement values of the cutting force measurement sensors 21a and 21b.

The machining device 10 to which the machining control system according to the present invention is applied is a common triaxially-controlled machine tool, for machining the shape of a cut target material 15 by spinning the working tool 14 to cut into the cut target material 15 and remove portions of the cut target material 15. At times, the working tool 14, the chassis 11 or the like may vibrate by the force that the working tool 14 receives from the cut target material 15, which may cause drawbacks such as the deterioration of surface roughness of the worked surface or the breaking of the working tool 14. The present invention is applicable to such common machining devices 10 by attaching a force sensor amplifier 20 and a control PC 30 thereto.

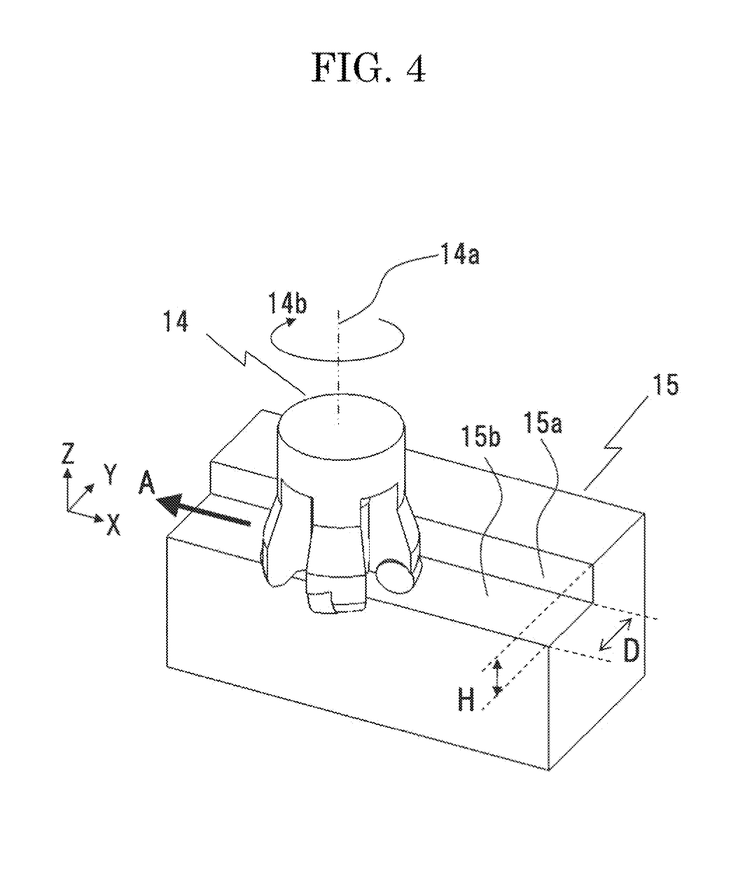

Next, one example of a cutting work subjected to abnormality detection will be described with reference to FIGS. 4, 5 and 6. The cutting work by rectilinear movement will be described with reference to FIG. 4. In FIG. 4, 14 denotes the cutting tool, and 15 denotes the cut target material. The cutting tool 14 is rotated via a drive motor not shown around a center axis 14a in the direction shown by 14b, and in this state, it is moved toward the direction of arrow A while forming a cut having width D and depth H. Thereby, a cut surface as denoted by 15a and 15b is formed to the cut target material, and cutting work is performed thereto. In the cutting work shown in FIG. 4, the cut depth and the working direction is fixed, so that effective control can be achieved even by adopting the prior art abnormality detection.

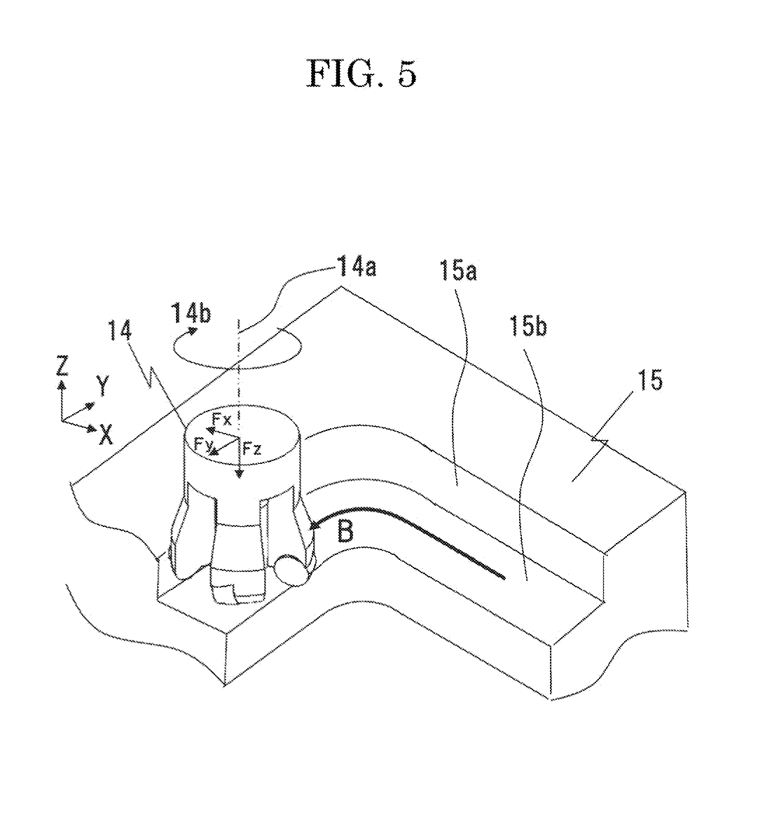

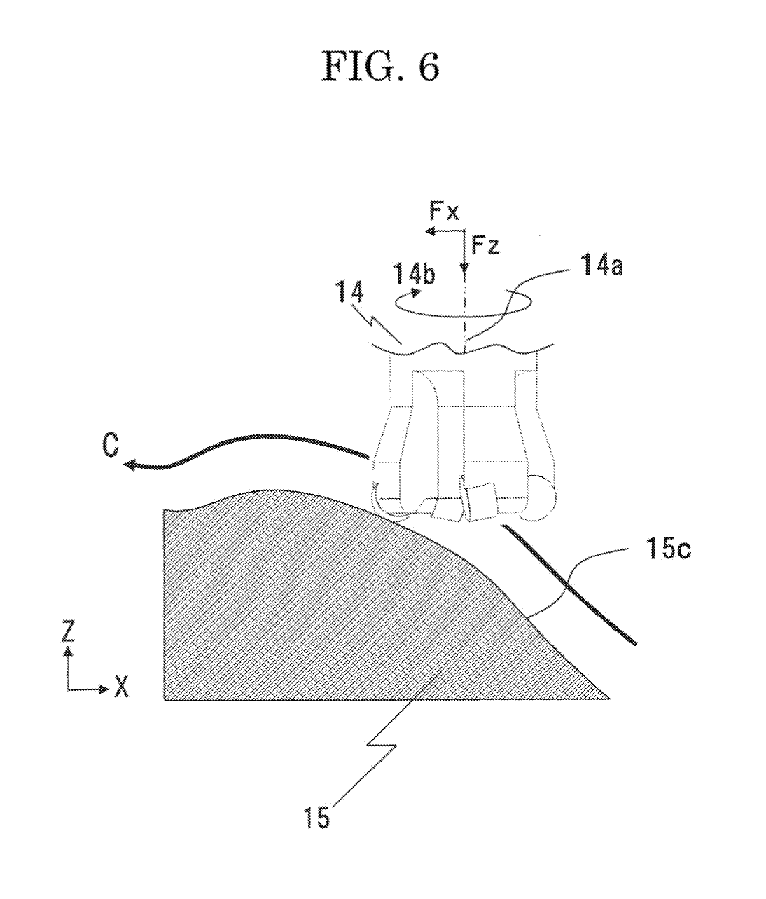

In contrast, a cutting work in which the cutout direction varies in the horizontal direction will be described with reference to FIG. 5, and a cutting work in which the cutout varies in the vertical direction will be described with reference to FIG. 6. In performing such working operation, a desired control can be performed if an NC machine tool is composed with a dedicated feedback-controlled NC system, but the control is complex and the device is expensive, and sufficient control cannot be expected by attaching an external sensor to a common NC machine tool to perform feedback control. The reason for this is because even if the cutting tool 14 is moved via NC, the vibration or cutting force at the current position cannot be detected, and desirable control cannot be performed. In FIG. 5, the cutting tool 14 moves horizontally but along a curved line for machining, as shown in arrow B. Thereby, cut surfaces as denoted by 15a and 15b are formed to the cut target material 15, and cutting work is carried out. If the cutting tool 14 is ordered to move along a trajectory whose moving direction is not linear, the cutting force will vary momentarily in X and Y directions according to the cutting position, so that the setting of threshold value for abnormality determination becomes difficult since the position of the detected data being taken in cannot be specified. Especially in FIG. 5, the width of the cut surface 15b is fixed, but actually the width of 15b is often not fixed, so that the setting of threshold value becomes even more difficult. According to the prior art, it is not possible to adopt a method to detect abnormality in the respective locations, and the location where cutting force becomes maximum is acquired by experiment in advance, and based on the value at that position, a method for detecting abnormality based on the value at that position is selected realistically. FIG. 6 illustrates a cutting work in which the cutout varies in the vertical direction (Z-axis direction) as in machining a curved surface, wherein the cutting tool is moved in the direction of arrow C to form a curved surface 15c in the cut target material 15. In the case of FIG. 6, similar to the cutting work of FIG. 5, the cutting force varies momentarily in the X direction and the Z direction according to the cutting position, so that it becomes difficult to set the threshold value for determining abnormality. Therefore, according to the control method of the present invention, abnormality determination of the processing is performed via a processing flowchart described hereafter.

FIG. 1 illustrates a processing flowchart of the method for determining the working abnormality according to the present invention. At first, a step of acquiring the working position information of the currently performed cutting work (S1) is carried out by the machining device 10 via the NC device 17 from the control PC 30 side. Next, a step of detecting the cutting force during machining (S2) is carried out by the cutting force measurement sensors 21a and 21b attached to the machining device 10. Thereafter, a step of accumulating the cutting forces acquired in S2 over time to create a cutting force pattern, and comparing the cutting force pattern (actual cutting force pattern) with cutting force patterns of calculated values saved in advance (model cutting force patterns) to extract a matching cutting force pattern of calculated values (model cutting force pattern) (S3) is carried out. Next, based on the compared result, a step of calculating a displacement between the actual cutting position and the acquired position information (delay time for acquiring cutting force) (S4) is carried out. Thereafter, based on the calculated result of delay time, a step of determining a comparison value as a predicted value of cutting force saved in advance (S5) is carried out. Next, a step of determining working abnormality (S6) is carried out by comparing the predicted value of the comparison target determined in the aforementioned step (S5) (cutting force at a specific coordinate position via a model cutting force pattern) and the measured cutting force (actual cutting force at that specific coordinate position).

Hereafter, the respective steps will be described in detail. In the step of acquiring the position information of cutting work (S1), the respective axial coordinate values of the working tool 14 of the machining device 10 is acquired using the machining control PC 30 via the NC device 17 of the machining device 10. In an ordinary numerically-controlled machine tool, an I/O port for communicating with the machining control PC 30 via the NC device 17 is normally provided, and by communicating through the I/O port, the current value of the coordinate values of respective axes as working position can be acquired. In other words, by inquiring the current position information from the machining control PC 30 to the NC device 17, the current X-axis, Y-axis and Z-axis values are output from the NC device 17. The working position can be acquired in this manner, but since the values are influenced by the clock frequency and transmission speed for communication, the acquired coordinate values of the respective axes do not correspond to the working position of the cutting process at the moment the acquisition command is output. The present invention aims at solving such positional inconsistency.

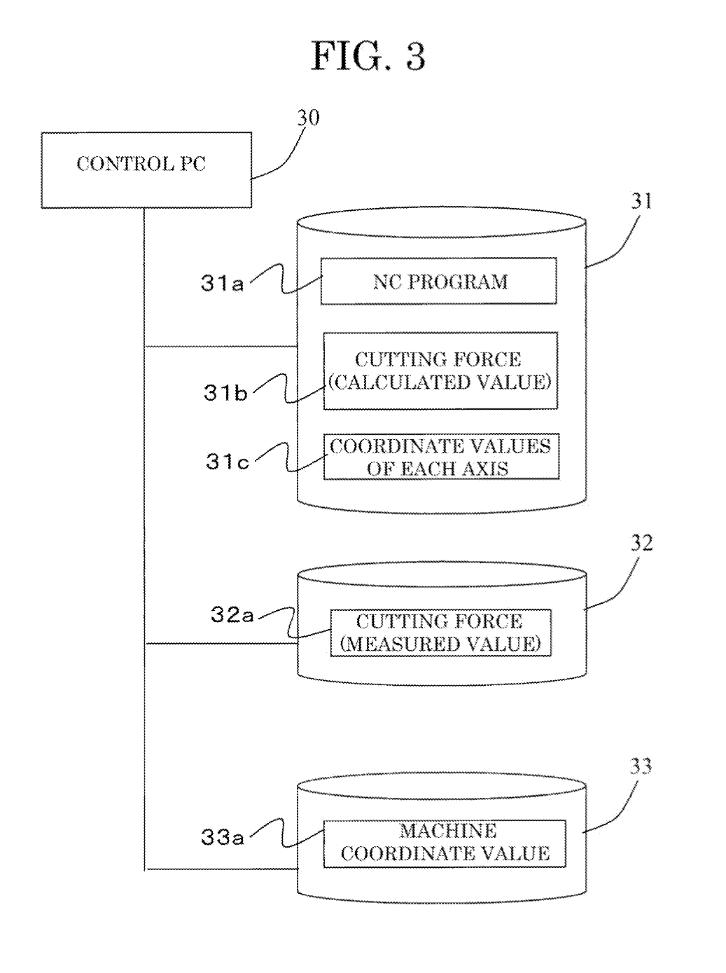

FIG. 3 illustrates a data storage unit of the machining control PC 30. The configuration of the data storage unit is divided largely into three layers, wherein a first layer 31 stores an NC program 31a for moving the machining device 10, a calculated value 31b of the cutting force corresponding to the cutting position information, and coordinate values 31c of various axes of the machining device at that time. A second layer 32 stores the cutting force 32a acquired by the cutting force sensors 21a and 21b attached to the machining device 10 during the cutting operation. A third layer 33 stores a working position information 33a of the cutting operation acquired by the machining device 10.

Next, the step of detecting the cutting force during processing (S2) will be described. In FIG. 2, force sensors 21a and 21b can be attached to a common NC machine tool by building the sensor into the table 16 or the spindle stage 12 or by positioning the sensor between the cut target material 15 and the table 16. The loads in the X, Y and Z-axis directions applied on the cutting tool 14 during cutting can be detected as cutting forces by the force sensors 21a and 21b. The signals from the force sensors 21a and 21b are converted via the force sensor amplifier 20 into electric signals, and stored in the machining control PC 30. At this time, the cutting load can also be measured by measuring a driving current value of a spindle motor (not shown) instead of the force sensor 21a built into the spindle stage 12, but the current value of the spindle mainly shows the rotational fluctuation of the cutting tool 14 and cannot be used to calculate the load applied in the respective axial directions (X, Y and Z-axis directions), and in addition, a component disposed in the spindle motor (such as a rotor) is rotated at high speed with inertial force, so that it is more preferable to adopt the cutting force measurement using the force sensors 21a and 21b as according to the present invention as a method for extracting the fluctuation component of the cutting load in detail. However, it is possible to calculate in advance an additional pattern using the current value of the spindle motor, and to apply the same to the abnormality determination according to the present invention.

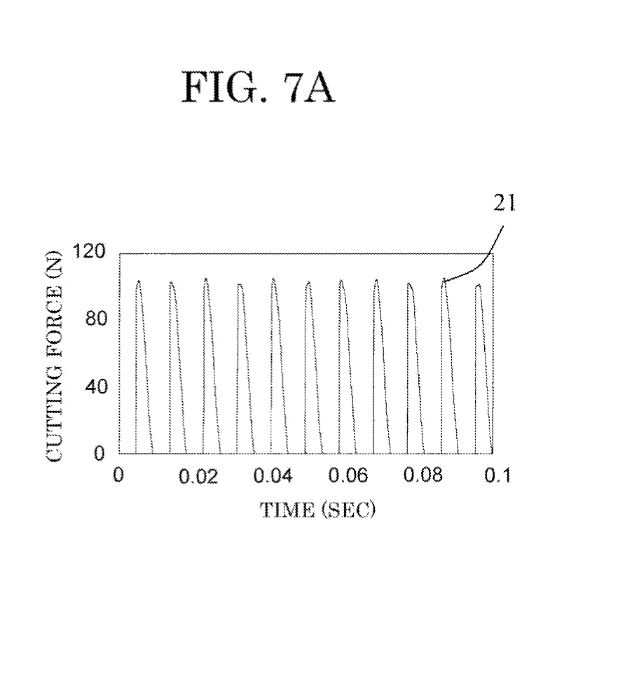

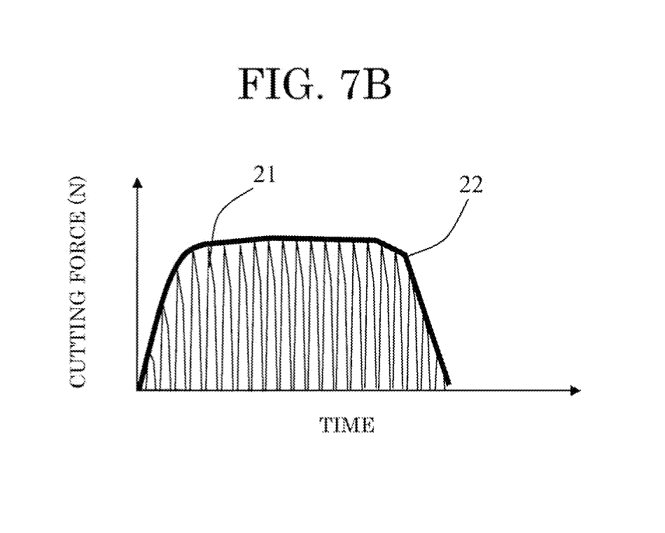

Now, the actual example of the measurement of cutting force using the force sensors 21a and 21b will be described. FIG. 7A shows an example of the cutting force signals acquired from the force sensors 21a and 21b during stationary cutting conditions, such as rotating a double-edged blade tool at a tool rotation speed of 3300/min (rpm) and performing rectilinear cutting as shown in FIG. 4. In response to the tool rotation speed, cutting forces 21 are acquired at 0.009-second intervals. As shown in FIG. 7A, there are times when the blade edge of the cutting tool 14 runs idly, so that cutting force is applied intermittently. As shown, when the cutout is constant as shown in FIG. 4, the measurement result of cutting forces will be constant as shown in FIG. 7A, and in this state of cutting work, the displacement between the actual cutting position and the acquired positional information (delay time for acquiring cutting force) is not a big issue, and the setting of the threshold value is easy. On the other hand, in general cutting works as illustrated in FIGS. 5 and 6, the cutting force signals acquired from the force sensors 21a and 21b show that the cutting forces 21 fluctuate and vary according to the cutting trajectory, based on the change of cutouts to the various axial directions. Here, a curved line (profile) having the maximum value of the cutting force 21 extrapolated is shown as a cutting force curve 22 (cutting force pattern). Such a profile curve is not acquired as the result of measurement, but acquired by extrapolate the maximum value of the actually measured cutting force by the control PC 30.

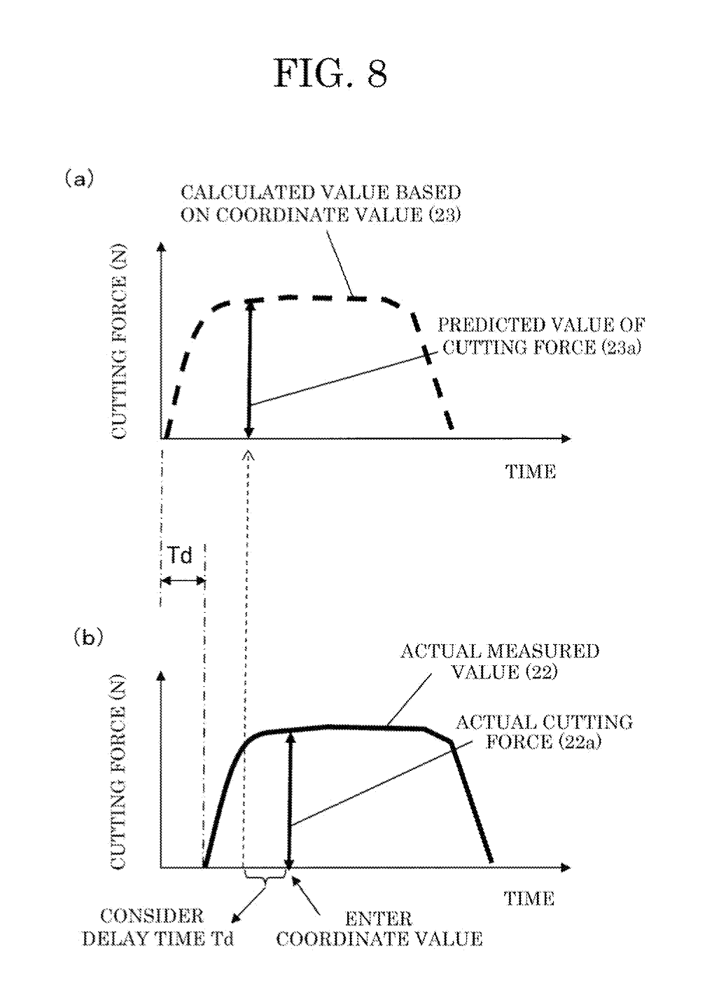

Next, FIG. 8 is referred to in describing the step of extracting the cutting force pattern of the calculated value saved in advance via comparison with the acquired cutting force pattern (S3), and the method thereof.

At first, the change value of the cutting force is calculated via calculation based on work conditions set in advance. The cutting force can be calculated based on the shape of the tool and the work conditions, by using a commercially available FEM analysis software for calculation or adopting a method of calculation based on cutting depth and generated chip length. Such techniques are well known, so that detailed descriptions thereof are not provided in the present specification. Based on the cutting force calculated via such well-known means, a cutting force curve 23 (model cutting force pattern) shown by the dotted line of FIG. 8 is calculated. The cutting fore curve 23 (model cutting force pattern) stores multiple cutting force curves (model cutting force patterns) corresponding to multiple tool shapes and multiple work conditions (surface shapes of the cutting work and the like) as calculated values 31b of cutting force corresponding to the cut position information of the first layer 31 of the data storage unit in the machining control PC 30 (FIG. 3).

The calculated cutting force curve 23 (model cutting force pattern) and the cutting force curve 22 of the actual cutting force (actual cutting force pattern) acquired in S2 are compared based on the machining coordinate value acquired in S1, and a pattern having a matching profile is extracted (S3). FIG. 8 shows one example thereof, wherein by setting each acquired coordinate value as reference, a model cutting force pattern in which the change values of the cutting force curves 22 (actual cutting force pattern) and 23 (model cutting force pattern) substantially match can be extracted.

The present extraction of model cutting force pattern can be performed by comparing the model cutting force pattern and the actual cutting force pattern after a series of processes have been completed to thereby extract a substantially identical model cutting force pattern, or can be performed by comparing the patterns at mid-stage. When the model cutting force pattern is extracted after a series of processes have been completed, the comparison between the actual cutting force and the predicted value of cutting force is performed at the time the subsequent processing is to be performed. If the model cutting force pattern is extracted through comparison of patterns at mid-stage, the extraction can be used for detecting the subsequent working abnormality to control the machining force.

Next, we will describe the step of calculating displacement (delay time) (S4) between the actual cutting position and the acquired position information based on the result of comparison between the cutting force curve 22 (actual cutting force pattern) and the cutting force curve 23 (model cutting force pattern).

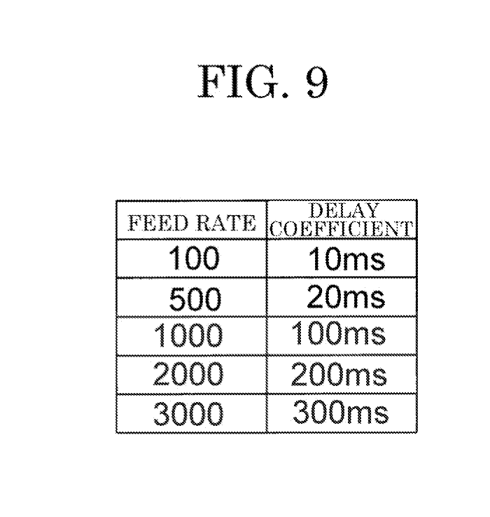

As shown in FIG. 8, by having the pattern of the cutting force curve of S3 extracted, the amount of displacement of time of the cutting force curve 22 (actual cutting force pattern) from the cutting force curve 23 (model cutting force pattern) is calculated by comparing the cutting force curve 22 (actual cutting force pattern) and the cutting force curve 23 (model cutting force pattern). In FIG. 8, it can be seen that the cutting force curve 22 acquired via measurement is delayed by time Td from the calculated cutting force curve 23. This is because the cutting force curve 22 can be calculated substantially in real time since it is calculated based on the coordinate value acquired via the NC device 17, while the cutting force curve 23 is measured by the control PC 30 which acquires the signal from the force sensor 20, so that a delay corresponding to the transmission time occurs, which is detected as delay. As described, by comparing the cutting force curves 22 and 23 and calculating the amount of time variation required to substantially match the two patterns, the delay time Td illustrated in FIG. 8 can be calculated. This delay time Td is increased as the feed rate of the tool is increased. Now, as shown in FIG. 9, it is possible to store the delay time Td in advance in the table having two values, the feed rate and the delay coefficient, as parameters, and to control the starting of machining by referring to these parameters. Further, in actual machining, it is possible to calculate the delay time with further accuracy from the start of the machining by computing the delay quantity (time: Td) in real time with respect to the parameters set in advance (FIG. 9) so as to update the values in the table as parameters by the actually calculated Td. In general, it is possible to adopt a method in which when machining is started from a machining start point, control is performed using the parameter set in advance (FIG. 9), and then control is performed based on the delay time Td acquired by measurement.

Next, based on the calculated result of delay time Td, a step of determining a comparison value (S5) as a predicted value 23a of cutting force of the model cutting force pattern stored in advance is carried out. Therefore, if the delay time Td is calculated, the cutting forces of the respective axial directions can be compared by comparing the predicted value 23a of the cutting force advanced by delay time Td from the actual cutting force 22a (refer to FIGS. 8(a) and 8(b)), so that the cutting force component to be compared can be determined even if the worked surface is slanted and the cutting forces in the X, Y, and Z-axis directions vary momentarily.

Next, a step of determining abnormality of the actual force 22a (S6) with respect to the comparison value 23a determined in S5 is carried out. In the present abnormality determination step (S6), not necessarily all three directions (X, Y and Z-axis directions) must be subjected to abnormality determination, and it is sufficient to determine abnormality in a representative direction, such as by using a force Fy of a signal component in the diameter-cutting direction as shown in FIG. 5. Further, determination can be performed via a force of a signal component in the direction in which the fluctuation of quantity of cutting condition appears significantly (such as force Fz in FIG. 6). The direction in which the fluctuation of quantity of cutting condition appears significantly is determined by the direction of movement of the tool, for example. The method for calculating the threshold value for abnormality determination depends on the rigidity of the working tool 14 and the cut target material 15 with respect to the level of cutting force, the amount of cutting in the radial or axial direction, wherein by computing the values having added a margin to the cutting forces calculated in advance via simulation or by experiment as threshold values for respective conditions and to set the same in a table, they can be used as threshold values for abnormality determination. In the abnormality determination step (S6), the cutting abnormality can be detected by comparing the actual cutting force 22a acquired in S5 and the threshold value for detecting abnormality. According to the present embodiment, it is possible to provide a method for determining the threshold value for detecting abnormality dynamically in a working path where the diameter cutting quantity varies momentarily, contributing to preventing the occurrence of defective products formed by processing failure and cutting down manufacturing costs.

### Embodiment 2

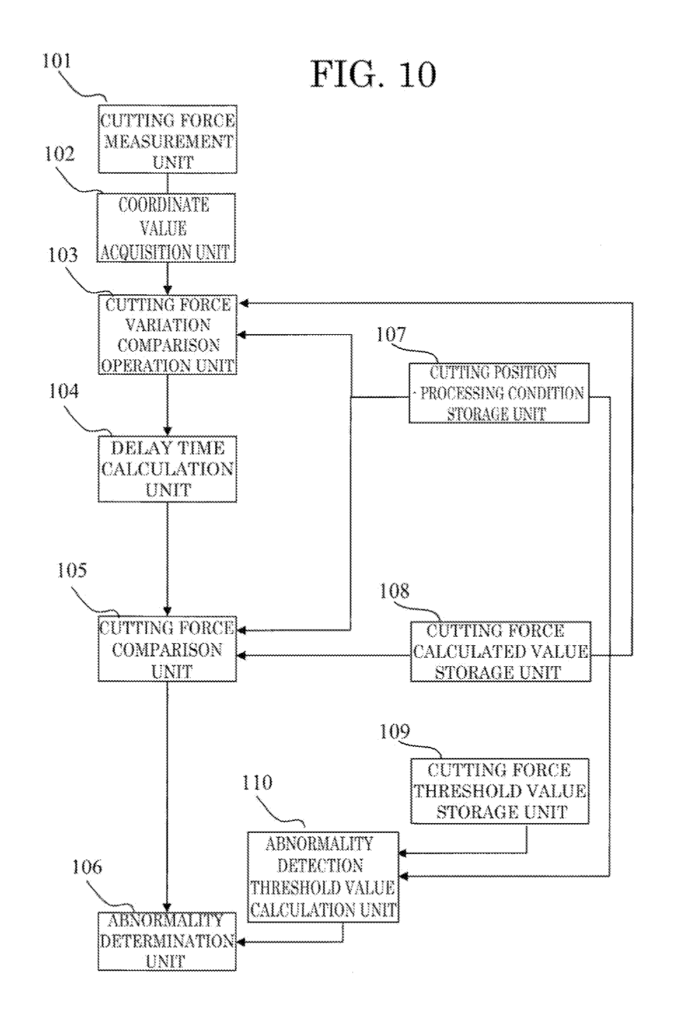

Now, a system configuration of a working abnormality detecting device as a second embodiment of the present invention will be described with reference to FIG. 10. FIG. 10 is a view showing the relationship between components for describing a preferred embodiment of the working abnormality detecting device. The working abnormality detecting device according to the present invention is composed of a cutting force measurement unit 101, a coordinate value acquisition unit 102, a cutting force variation comparison operation unit 103, a delay time calculation unit 104, a cutting force comparison unit 105, an abnormality determination unit 106, a cutting position—work condition storage unit 107, a calculated cutting force storage unit 108, a threshold cutting force storage unit 109, and an abnormality detection threshold value calculation unit 110.

The cutting force measurement unit 101 is a means for measuring the cutting load applied on the tool as cutting force using a piezoelectric element-type force sensor. The force sensor can be built into the table 16 or the spindle stage 12 of the machining device 10 illustrated in FIG. 2, or can be placed between the cut target material 15 and the table 16. The coordinate value acquisition unit 102 is a means for acquiring the current working position of the machining device 10 via the NC device 17. The cutting force variation comparison operation unit 103 is a means for extracting the cutting force stored in the calculated cutting force storage unit 108 based on the variation quantity of cutting force acquired in the cutting force measurement unit 101 and the information stored in the cutting position—work condition storage unit 107, and performing a comparison operation. The delay time calculation unit 104 is a means for calculating the delay time between the actual cutting force acquired by the cutting force measurement unit 101 and the compared calculated cutting force (model cutting force pattern). The cutting force comparison unit 105 is a means for comparing the acquired value of the actual cutting force and the calculated value (model value), by taking the calculated delay time into consideration. The abnormality determination unit 106 determines whether abnormality has occurred by comparing the actual cutting force with a given threshold value that the abnormality detection threshold value calculation unit 110 acquires from the threshold cutting force storage unit 109.

The cutting position—work condition storage unit 107 associates and stores the work conditions such as the cutouts or feed rates based on cutting positions. The calculated cutting force storage unit 108 stores the calculated values of cutting forces based on cutting positions. The threshold cutting force storage unit 109 associates and stores the work conditions and the threshold values.

According to the present embodiment, it becomes possible to provide a method for determining the threshold value for detecting abnormality dynamically in a working path where the diameter cutting quantity varies momentarily, so that it contributes to preventing the occurrence of defective products formed by processing failure, and cutting down manufacturing costs.

The actual examples for carrying out the preferred embodiments of the present invention have been described, but the present invention is not restricted to the illustrated embodiments, and various changes can be made within the scope of the invention.

### REFERENCE SIGNS LIST

### 11 Chassis

12 Spindle table

### 13 Spindle

14 Cutting tool
15 Cut target material

### 16 Table

17 NC device
20 Force sensor amplifier
21 Cutting force
21a, 21b Force sensor
22 Actually measured value
22a Actual cutting force
23 Calculated value of cutting force
23a Predicted value of cutting force
30 Machining control PC
101 Cutting force measurement unit
102 Coordinate value acquisition unit
103 Cutting force variation comparison operation unit
104 Delay time calculation unit
105 Cutting force comparison unit
106 Abnormality determination unit
107 Cutting position—work condition storage unit
108 Calculated cutting force storage unit
109 Threshold cutting force storage unit
110 Abnormality detection threshold value calculation unit

1. A working abnormality detecting device for a machine tool subjected to numerical control, comprising:
a cutting position—work condition storage means storing a work condition related to a coordinate value of a cutting tool during cutting work;
a calculated cutting force storage means for storing a calculated value of a cutting force associated with the coordinate value of the cutting tool;
a measurement means for measuring an actual cutting force of the cutting tool during the cutting work;
a coordinate value acquisition means for acquiring an actual coordinate value of the cutting tool during the cutting work;
a calculated cutting force pattern extraction means for extracting identical patterns by comparing a pattern of a calculated cutting force stored in advance by the calculated cutting force storage means and a pattern of the actual cutting force acquired via the measurement means;
a delay time computing means for computing a delay time of the actual cutting force by comparing the actual cutting force pattern and the calculated cutting force pattern via the calculated cutting force pattern extraction means;
a threshold cutting force storage means for storing a threshold cutting force for determining abnormality based on the work condition associated with the coordinate value of the cutting tool; and
an abnormality determination means for determining whether there is abnormality or not by comparing the actual cutting force of the cutting tool at the coordinate value and the threshold cutting force for determining abnormality.

2. The working abnormality detecting device for a machine tool according to claim 1, wherein
the measurement means is composed of a force sensor built into a spindle section of a machining device.

3. The working abnormality detecting device for a machine tool according to claim 2, wherein
the measurement means is composed of a force sensor disposed between a table of the machining device and a cut target material.

4. A working abnormality detecting method for a machine tool subjected to numerical control, comprising:
a first step of acquiring a coordinate position information of a cutting tool during cutting work;
a second step of acquiring an actual cutting force during cutting work;
a third step of comparing a pattern of the actual cutting force acquired in the second step and a pattern of a cutting force predicted in advance by calculation;
a fourth step of calculating a delay time between the pattern of the cutting force predicted based on the comparison result and the pattern of the actual acquired cutting force;
a fifth step of determining a predicted value according to the cutting force pattern stored in advance based on the calculated delay time; and
a sixth step of determining whether working abnormality has occurred by comparing the predicted value and the measured actual cutting force.
